(19) United States
(12) Patent Application Publication
(10) Pub. No.: US 2022/0276654 A1
(43) Pub. Date: Sep. 1, 2022

(54) APPARATUS FOR GENERATING MULTIPLE PATHS FOR MOBILE ROBOT AND METHOD THEREOF

(71) Applicants: Hyundai Motor Company, Seoul (KR); Kia Corporation, Seoul (KR)

(72) Inventors: Hwan Hee Lee, Anyang (KR); Jun Yeong Choi, Seoul (KR)

(21) Appl. No.: 17/518,907

(22) Filed: Nov. 4, 2021

(30) Foreign Application Priority Data
Feb. 26, 2021 (KR) 10-2021-0026953

(51) Int. Cl. G05D 1/02; G05B 19/4155

(52) U.S. Cl. CPC G05D 1/0214; G05D 1/0217; G05D 1/0274; G05B 19/4155; G05B 2219/50391

(57) ABSTRACT

An apparatus for generating multiple paths for a mobile robot includes a multi-path generation module that detects “n” multiple waypoints located at a maximum straight line distance without collision with an obstacle in a space within a predetermined radius in “n” directions centered on the mobile robot, and plans “n” multiple paths to a destination by passing through each of the multiple waypoints as an initial waypoint, and an optimal path selection module that selects a path satisfying a preset cost function requirement among the “n” multiple paths, which are planned, as an optimal path, making it possible to select the optimal path suitable for various driving situations of the mobile robot by simultaneously generating multiple paths along which the mobile robot is to travel from its current location to its destination.

### CROSS-REFERENCE TO RELATED APPLICATION

This application claims under 35 U.S.C. § 119(a) the benefit of Korean Patent Application No. 10-2021-0026953, filed in the Korean Intellectual Property Office on Feb. 26, 2021, the entire contents of which are incorporated herein by reference.

### BACKGROUND

### (a) Technical Field

The present disclosure relates to an apparatus and method for simultaneously generating multiple paths for a mobile robot, which enable the mobile robot to reach the same destination from a current location.

### (b) Description of the Related Art

In general, a mobile robot is an apparatus that can autonomously move based on its own judgment and perform scheduled tasks without the control of an administrator for movement.

For movement of the mobile robot, a movement path is generated, which allows the mobile robot to reach a destination by avoiding structures and obstacles arranged in various places in a space where the movement is scheduled, and control is performed such that the mobile robot is driven to travel straight or rotate along the movement path, for example.

Accordingly, various techniques have been used for generating an optimal path, including methods such as the Dijkstra algorithm, the A* algorithm, the JPS (Jump Point Search) algorithm, and the RRT (Rapidly-exploring Random Tree) algorithm.

However, in the related art, when generating a path along which a single mobile robot is to move, it is common that only one optimal path is generated using various algorithms and movement is controlled along the one optimal path.

Accordingly, there is a problem in that it is difficult to select a path suitable for different driving conditions of a mobile robot that may be required, such as when the shortest distance movement is required, when cumulative rotation needs to be kept to a minimum, or when natural driving is required because a direction of an immediately-previous path is similar.

That is, in the related art, since only one movement path is generated for one mobile robot, there is a problem in that it is impossible to select another path suitable for various driving conditions required in moving to a destination.

### SUMMARY

An aspect of the present disclosure provides an apparatus and method for generating multiple paths for a mobile robot, the apparatus including a multi-path generation module that detects “n” multiple waypoints located at the maximum straight line distance without collision with an obstacle in “n” directions centered on the mobile robot and plans “n” multiple paths to a destination by passing through each of the multiple waypoints as an initial waypoint, and an optimal path selection module that selects a path satisfying a preset cost function requirement among the “n” multiple paths planned, as an optimal path, making it possible to select the optimal path suitable for various driving conditions of the mobile robot by simultaneously generating multiple paths along which the mobile robot (i.e., a single mobile robot) is to travel from its current location to its destination.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for generating multiple paths for a mobile robot includes a cost map generation module that generates a cost map in which a cost is differentially allocated to areas according to a distance from an obstacle by using map information on a space divided into a plurality of areas and obstacle information on an obstacle in the space, a multi-path generation module that detects “n” multiple waypoints located at a maximum straight line distance without collision with the obstacle in “n” directions centered on the mobile robot, and plans “n” multiple paths to a destination by passing through each of the multiple waypoints as an initial waypoint, an optimal path selection module that selects a path satisfying a preset cost function requirement among the “n” multiple paths planned, as an optimal path, and a path control module that transmits a control signal for controlling the mobile robot to follow the selected optimal path to reach the destination to a robot driver of the mobile robot.

The cost map generation module may include an information receiver that receives and stores the map information in which the space in which the mobile robot is movable is divided into the plurality of areas and information about the obstacle located in the space, and a cost allocator that differentially allocates the cost according to how far each area resulting from division of the space is from the obstacle and then generates a cost map by matching the costs to the areas respectively.

The cost allocator may allocate a relatively high cost as an area resulting from division of the space is closer to the obstacle, allocate a lowest cost to a farthest area by linearly decreasing the cost as the area resulting from division of the space is further away from the obstacle, and store a cost value thereof along with the map information and the obstacle information.

The cost allocator may allocate a relatively high cost as an area resulting from division of the space is closer to the obstacle, allocate a relatively low cost to an area by non-linearly decreasing the cost rapidly as the area resulting from division of the space is further away from the obstacle, and store a cost value thereof along with the map information and the obstacle information.

The cost allocator may differentially allocate the cost to areas based on a distance from the area occupied by the obstacle, heat map information of maps, or obstacle recognition results.

The multi-path generation module may include a multi-waypoint detector that detects, as the “n” multiple waypoints, areas located on the maximum straight line distance without collision with an obstacle in “n” directions (n is an integer greater than or equal to 2) centered on the mobile robot located on the cost map, and a multi-path planning device that plans the “n” multiple paths to reach the destination by avoiding the obstacle while passing through each of the multiple waypoints as an initial waypoint.

The multi-path generation module may limit a space in which the multiple waypoints are able to be detected to a distance within a preset radius from the mobile robot.

The optimal path selection module may include a cost function factor determiner that determines a cost function factor for selecting a path from among the “n” multiple paths generated by the multi-path generation module, and a path selector that selects a path to a destination according to the cost function factor determined by the cost function factor determiner among the “n” multiple paths, as an optimal path to be followed by the mobile robot.

The cost function factor determiner may select and determine, as a cost function factor for path selection, one of a shortest distance, minimum cumulative rotation, a direction coincidence with an immediately-previous path, a direction coincidence with a direction pointed by the robot, a direction coincidence with a immediately-previous driving signal of the robot driver, cost map stability, or cost map congestion or a combination of at least two or more cost function factors selected.

When a driving condition requested from the mobile robot is to minimize a moving distance of the robot, the cost function factor determiner may determine a shortest distance as a cost function factor and the path selector selects a path having a shortest distance to the destination among the “n” multiple paths generated by the multi-path generation module as an optimal path.

When a driving condition requested from the mobile robot is to minimize rotation of the mobile robot among paths to the destination, the cost function factor determiner may determine minimum cumulative rotation as a cost function factor and the path selector selects a path of which a cumulative rotation value is a minimum among the “n” multiple paths generated by the multi-path generation module as an optimal path.

When a driving condition requested from the mobile robot is for the mobile robot to maintain a direction of a path along which the mobile robot had moved immediately previously to perform natural driving continuously, the cost function factor determiner may determine, as a cost function factor, a coincidence in direction with an immediately-previous path, and the path selector determines, as an optimal path, a path having a smallest difference in direction with the immediately-previous path among the “n” multiple paths generated by the multi-path generation module.

When a driving condition requested from the mobile robot is to maintain a traveling direction of the mobile robot, the cost function factor determiner may determine, as a cost function factor, a coincidence in direction with a direction pointed by the robot and the path selector determines, as an optimal path, a path having a smallest difference from a direction pointed by the robot among the “n” multiple paths generated by the multi-path generation module.

When the driving condition requested from the mobile robot is to minimize left and right rotation, the cost function factor determiner may determine, as a cost function factor, a coincidence in direction with an immediately-previous driving signal of the robot driver, and the path selector selects a path on left side as the optimal path, when the mobile robot is turning left using the immediately-previous driving signal of the robot driver, and selects a path on right side as the optimal path when the mobile robot is turning right.

According to an aspect of the present disclosure, a method for generating multiple paths for a mobile robot includes a cost map generation step of generating, by a cost map generation module, a cost map in which a cost is differentially allocated to areas according to a distance from an obstacle by using map information on a space divided into a plurality of areas and obstacle information on an obstacle in the space; a multi-path generation step of detecting, by a multi-path generation module, “n” multiple waypoints located at a maximum straight line distance without collision with the obstacle in “n” directions centered on the mobile robot, and planning “n” multiple paths to a destination by passing through each of the multiple waypoints as an initial waypoint; an optimal path selection step of selecting, by an optimal path selection module, a path satisfying a preset cost function requirement among the “n” multiple paths planned, as an optimal path; and a path control step of transmitting, by a path control module, a control signal for controlling the mobile robot to follow the selected optimal path to reach a destination to a robot driver of the mobile robot.

The cost map generation step may include an information reception process of receiving and storing the map information in which the space in which the mobile robot is movable is divided into the plurality of areas and information about the obstacle located in the space, and a cost allocation process of differentially allocating a cost according to how far each area resulting from division of the space is from an obstacle and then generate the cost map by matching the costs to the areas respectively.

The multi-path generation step may include a multi-waypoint detection process of detecting, as the “n” multiple waypoints, areas located on the maximum straight line distance without collision with an obstacle in the “n” directions (n is an integer greater than or equal to 2) centered on the mobile robot located on the cost map, and a multi-path planning process of planning the “n” multiple paths to reach the destination by avoiding the obstacle while passing through each of the multiple waypoints as an initial waypoint.

The multi-waypoint detection process may include limiting a space in which the multiple waypoints are able to be detected to a distance within a preset radius from the mobile robot.

The optimal path selection step may include a cost function factor determiner configured to determine a cost function factor for selecting a path from among the “n” multiple paths generated by the multi-path generation step, and a path selection process of selecting a path to the destination according to the cost function factor determined by the cost function factor determination process among the “n” multiple paths, as an optimal path to be followed by the mobile robot.

The cost function factor determination process may include selecting and determining, as a cost function factor for path selection, one of a shortest distance, minimum cumulative rotation, a direction coincidence with a immediately-previous path, a direction coincidence with a direction pointed by the robot, a direction coincidence with a immediately-previous driving signal of the robot driver, cost map stability, or cost map congestion, or a combination of at least two or more cost function factors.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a multi-path generating apparatus for a mobile robot according to the present disclosure;

FIG. 2 is an exemplary view of a cost map generated by a cost map generation module according to the present disclosure;

FIG. 3 is an exemplary view of multiple waypoints detected by a multi-path generation module according to the present disclosure;

FIG. 4 is an exemplary view of multiple paths planned in a multi-path generation module according to the present disclosure;

FIGS. 5 to 10 are exemplary views of optimal paths that are appropriately selected for various driving conditions in an optimal path selection module according to the present disclosure; and

FIG. 11 is a block diagram of a method for generating multiple paths for a mobile robot according to the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

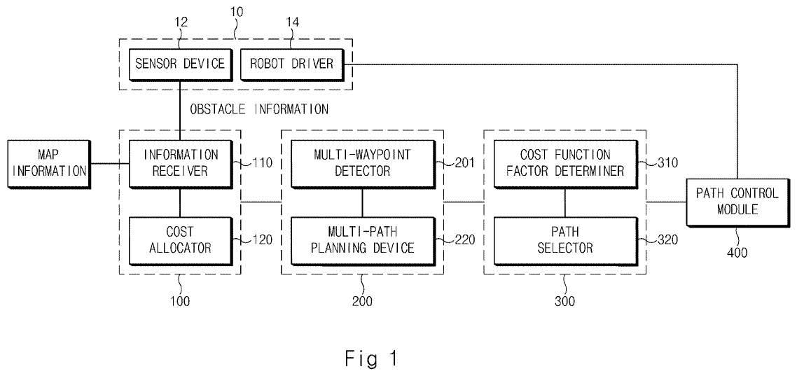

Embodiments of the present disclosure will be described below in detail with reference to FIGS. 1 to 11.

FIG. 1 is a block diagram of an apparatus for generating multiple paths for a mobile robot according to the present disclosure.

Referring to FIG. 1, an apparatus for generating multiple paths for a mobile robot according to the present disclosure may include a cost map generation module 100 that generates a cost map in which a cost is differentially allocated to areas according to a distance from an obstacle by using map information on a space divided into a plurality of areas and obstacle information on an obstacle in the space, a multi-path generation module 200 that detects “n” multiple waypoints located at the maximum straight line distance without collision with an obstacle in a space within a predetermined radius in “n” directions centered on the mobile robot, and plans “n” multiple paths to a destination by passing through each of the multiple waypoints as an initial waypoint, an optimal path selection module 300 that selects a path satisfying a preset cost function requirement among the “n” multiple paths planned, as an optimal path, and a path control module 400 that transmits a control signal for controlling the mobile robot to follow the selected optimal path to reach a destination to a robot driver of the mobile robot.

The cost map generation module 100 may include an information receiver 110 that receives and stores map information in which a space in which the mobile robot is movable is divided into a plurality of areas and information on an obstacle located in the space, and a cost allocator 120 that differentially allocates a cost according to how far each area resulting from division of the space is from an obstacle and then generates a cost map by matching the costs to the areas respectively.

In this way, the cost map generated by the cost map generation module 100 may be stored in a storage device such as a separate memory, and used for detection of multiple waypoints and generation of multiple paths in the multi-path generation module 200.

In this case, the information receiver 110 may receive map information on a space to which the mobile robot is to move, and obstacle information transmitted from a sensor device 12 provided in a mobile robot 10 and obtain a space for generation of a cost map and data on an avoidance target.

The information receiver 110 may not only receive data on a space to which the mobile robot is to move as map information, but also divide and store the space into a plurality of areas, thereby improving the convenience of cost allocation for each area. The map information may include information on a currently obtained map as well as a previously obtained map.

In addition, the information receiver 110 may receive obstacle information transmitted after being recognized by the sensor device 12 including various obstacle detection sensors such as a camera or lidar provided in the mobile robot 10. The obstacle information may include information such as a location in the space to which the mobile robot is to move and the size and shape of an obstacle occupied in the space.

In addition, the cost allocator 120 may allocate a relatively high cost as an area resulting from division of the space is closer to the obstacle, and a relatively low cost as an area resulting from division of the space is further away from the obstacle, and then generate a cost map by storing a cost value thereof along with map information and obstacle information. Accordingly, the determination as to which area of areas is to be included in a path and which area of areas is to be avoided may be achieved merely by comparing the costs allocated to the areas with each other.

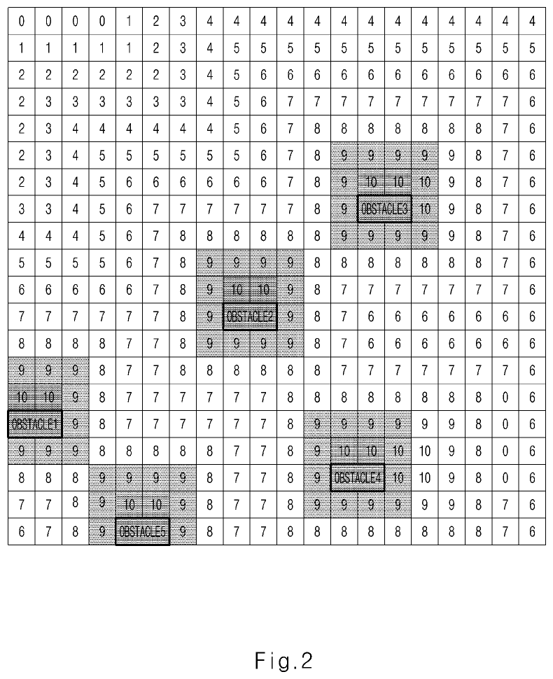

As an example of a cost map in which a cost is allocated to each area by the cost map generation module 100, as shown in FIG. 2, the highest cost of 10 is allocated to an area occupied by an obstacle, and a decreased cost is allocated as it is further away from the area occupied by the obstacle.

Accordingly, in FIG. 2, a cost map is generated in such a way that the cost linearly decreases as the distance from the area occupied by the obstacle increases and the lowest cost of 0 is allocated to the farthest area.

In this case, a high cost may be allocated when the distance to any one of a plurality of obstacles (obstacles 1 to 5) in a space is short, and a low cost may be allocated only when the distances from all obstacles are long.

In addition, the cost map generation module 100 may differently allocate a cost to areas in such a way that the cost decreases linearly as the distance increases from the area occupied by the obstacle as shown in FIG. 2. Of course, it is also possible to allocate a cost such that the cost decreases rapidly non-linearly as the distance increases.

That is, the costs allocated to areas by the cost allocator 120 are to distinguish between an area with a high probability of collision and an area without a high probability of collision. When considering that the probability of collision sharply decreases as the distance increases, it is possible to allocate a cost to decrease rapidly.

In addition, the cost allocator 120 may set, as cost conditions for differentially allocating the cost, not only a distance from the area occupied by the obstacle, but also heat map information of maps, obstacle recognition results, or the like to differently allocate a cost to the areas.

The multi-path generation module 200 may include a multi-waypoint detector 210 that detects, as “n” multiple waypoints, areas located on the maximum straight line distance without collision with an obstacle in “n” directions (n is an integer greater than or equal to 2) centered on the mobile robot located on the cost map and a multi-path planning device 220 that plans “n” multiple paths to reach a destination by avoiding the obstacle while passing through each of the multiple waypoints as an initial waypoint.

In this case, the multi-waypoint detector 210 may detect, as multiple waypoints, areas located at the maximum straight line distance without collision with an obstacle in each of a plurality of directions movable from the current position of the mobile robot. The multiple waypoints mean a plurality of waypoints through which a single mobile robot may pass when moving in different directions.

In addition, each of the multiple waypoints detected by the multi-waypoint detector 210 acts as an initial waypoint for planning multiple paths, so that a space in which the multiple waypoints may be detected is limited to a distance within a preset radius from the mobile robot.

In addition, the multi-waypoint detector 210 may set, as an area where there is no collision with an obstacle, an area allocated a cost of no greater than 8, which is lower than a cost of 10 indicating that a cost allocated to each area represents an area occupied by an obstacle on the cost map and is lower than a cost of 9 indicating that the cost allocated to each area represents a nearest area to the obstacle on the cost map, to avoid an area with collision with the obstacle. In this case, the multi-waypoint detector 210 may change and set a cost for determining an area without collision with obstacles to a value lower than or higher than 8.

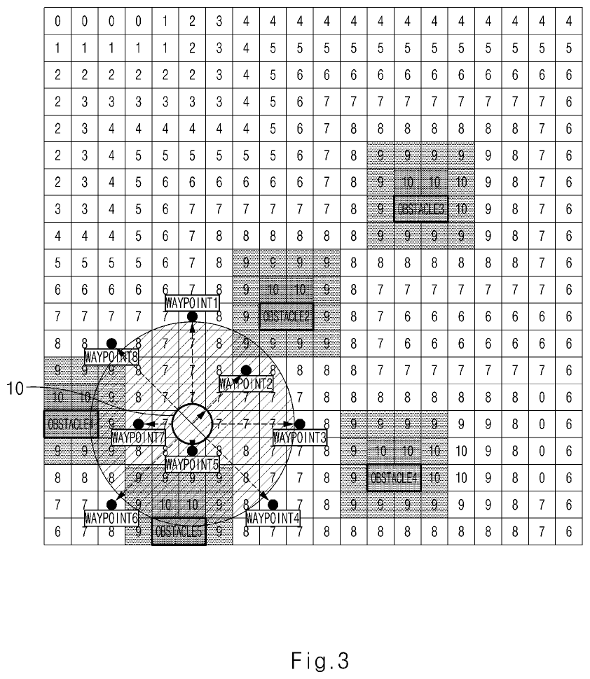

Accordingly, as shown in FIG. 3, the multi-waypoint detector 210 may detect, as multiple waypoints, areas located at the maximum distance, which are reached by passing through only areas with a cost of 8 or less on the cost map in eight directions within a certain radius from the mobile robot (indicated by a large circle around the mobile robot in FIG. 3) as shown in FIG. 3.

FIG. 3 shows that waypoint 1 to waypoint 8 are detected in the eight directions, and each waypoint detected as described above may mean an initial waypoint to which the mobile robot is able to move from a current position in each direction without colliding with an obstacle.

In addition, the multi-path planning device 220 may plan “n” multiple paths through which the mobile robot is able to reach a destination by avoiding the obstacle while passing through each of the multiple waypoints as the initial waypoint. In this case, planning “n” multiple paths may mean generating a path through which the mobile robot is able to reach the destination from the current location based on various algorithms.

The multiple paths may mean a plurality of paths through which one mobile robot is able to reach a destination, and in actual movement of a mobile robot, the mobile robot may move along any one of paths selected by the optimal path selection module.

In this case, the “n” multiple paths generated by the multi-path planning device 220 such that the mobile robot reaches the destination from the current position of the mobile robot via each initial waypoint may be generated according to various methods capable of generating an optimal path for movement of a robot, such as Dijkstra algorithm, A* algorithm, JPS (Jump Point Search) algorithm, RRT (Rapidly-exploring Random Tree) algorithm, or the like. In addition, the multi-path planning device 220 may perform post-processing such as shortening and interpolation in planning each of the multiple paths.

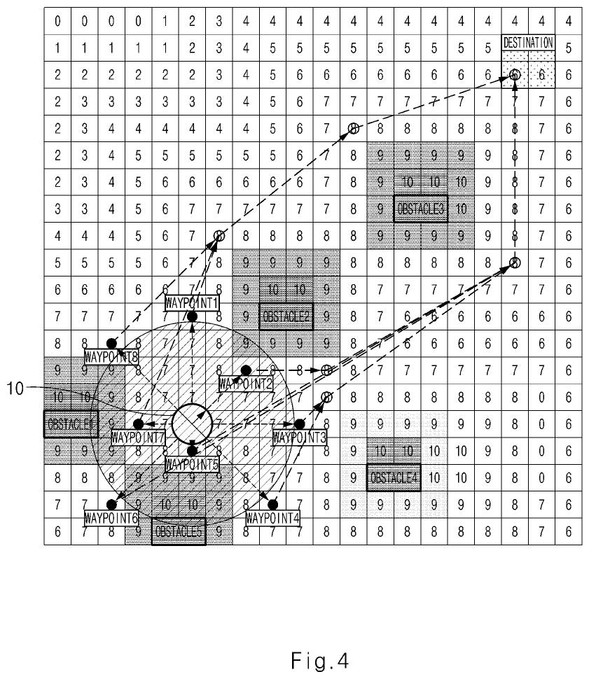

As an example of the multiple path planned by the multi-path planning device 220, as shown in FIG. 4, there are path 1 along which the mobile robot reaches a destination without collision with obstacle 2 and obstacle 3 after passing through waypoint 1, path 2 along which the mobile robot reaches a destination without collision with obstacle 2 and obstacle 3 after passing through waypoint 2, path 3 along which the mobile robot reaches a destination without collision with obstacle 4 and obstacle 3 after passing through waypoint 3, path 4 along which the mobile robot reaches a destination without collision with obstacle 4 and obstacle 3 after passing through waypoint 4, path 5 along which the mobile robot reaches a destination without collision with obstacle 5, obstacle 2 and obstacle 3 after passing through waypoint 5, path 6 along which the mobile robot reaches a destination without collision with obstacle 5, obstacle 2 and obstacle 3 after passing through waypoint 6, path 7 along which the mobile robot reaches a destination without collision with obstacle 1, obstacle 2 and obstacle 3 after passing through waypoint 7, and path 8 along which the mobile robot reaches a destination without collision with obstacle 2 and obstacle 3 after passing through waypoint 8.

Accordingly, the multi-path planning device 220 may generate a plurality of paths as many as the number of multiple waypoints detected by the multi-waypoint detector 210 to generate the plurality of paths selectable when the one mobile robot is to reach a destination from a current location.

In addition, the optimal path selection module 300 may include a cost function factor determiner 310 that determines a cost function factor for selecting a path from among the “n” multiple paths generated by the multi-path generation module, and a path selector 320 that selects a path to a destination according to the cost function factor determined by the cost function factor determiner 310 among the “n” multiple paths, as an optimal path to be followed by the mobile robot.

In this case, the cost function factor determiner 310 may select various cost function factors or a combination of at least two or more cost function factors according to a driving condition requested during the movement of the mobile robot to reach the destination.

Accordingly, the cost function factor determiner 310 may select and determine, as a cost function factor for path selection, one of various cost function factors, such as a shortest distance, minimum cumulative rotation, a direction coincidence with the previous path, a direction coincidence with a direction pointed by the robot, a direction coincidence with an immediately-previous driving signal of the robot driver, cost map stability, cost map congestion, or the like, or a combination of at least two or more cost function factors.

The path selector 320 may select an optimal path to be followed by the mobile robot according to one cost function factor or a combination of at least two or more cost function factors selected by the cost function factor determiner 310.

As described above, the path selector 320 may easily select a suitable path of a plurality of paths for one mobile robot to reach the same destination from a current location and adopt the suitable path as a path of the mobile robot, thereby enabling the mobile robot to follow a path suitable for a driving condition through path diversification.

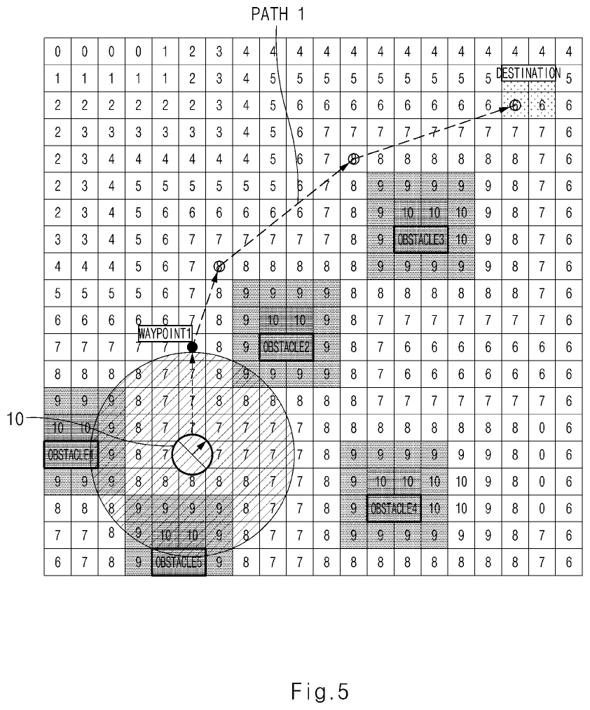

An example of selecting an optimal path suitable for a driving condition, which is requested from the mobile robot in the optimal path selection module 300, among multiple paths will be described below with reference to FIGS. 5 to 10.

First, as shown in FIG. 5, when a driving condition requested from the mobile robot is to minimize a moving distance of the robot, the cost function factor determiner 310 may determine the shortest distance as a cost function factor and the path selector 320 may select path 1 having the shortest distance to the destination among the eight multiple paths generated by the multi-path generation module 200 as the optimal path.

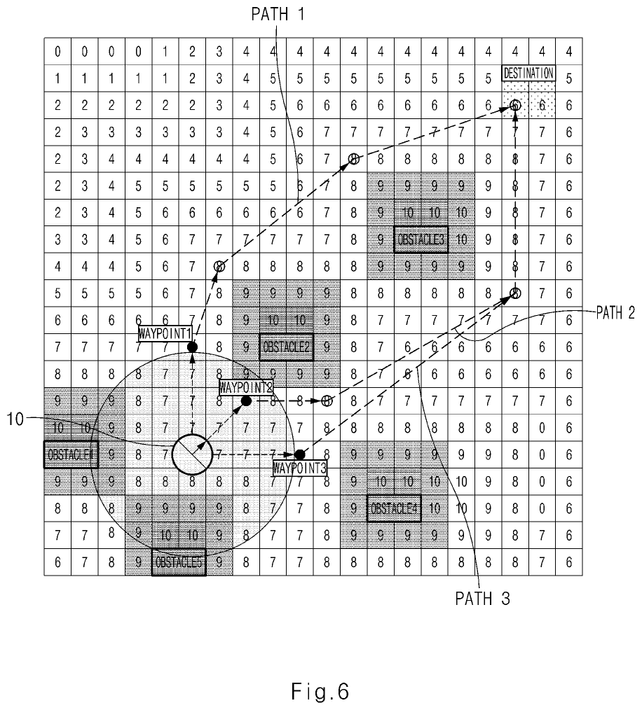

In addition, as shown in FIG. 6, when a driving condition requested from the mobile robot is to minimize rotation of the mobile robot among paths to the destination, the cost function factor determiner 310 may determine minimum cumulative rotation as a cost function factor and the path selector 320 may select path 1 of which the cumulative rotation value is the minimum among the eight multiple paths generated by the multi-path generation module 200 as the optimal path.

In addition, when the cost function factor is determined by a combination of the shortest distance and the minimum cumulative rotation in the cost function factor determiner 310, as shown in FIG. 6, the path selector 320 first may select path 1 to path 3 having similar cumulative rotation values as candidate paths, and select path 1 having the shortest distance to the destination from among the candidate paths selected, as an optimal path.

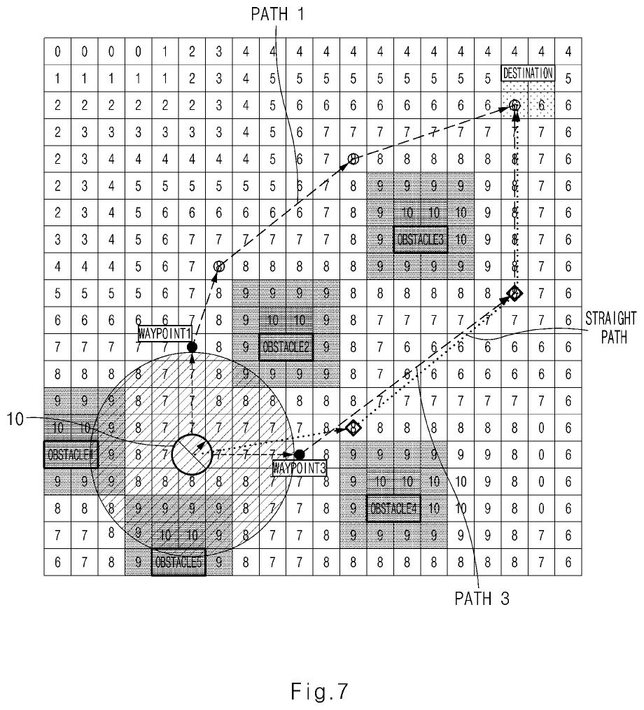

In addition, as shown in FIG. 7, when the driving condition requested from the mobile robot is for the mobile robot to maintain a direction of a path along which the mobile robot had moved immediately previously as much as possible to perform natural driving continuously, the cost function factor determiner 310 may determine, as a cost function factor, a coincidence in direction with the immediately-previous path, and the path selector 320 may determine, as an optimal path, path 3 having a smallest difference in direction with the immediately-previous path among eight multiple paths generated by the multi-path generation module 200.

For example, in the situation shown in FIG. 7, when there is a need to modify a path because obstacle 2 suddenly appears while the mobile robot is traveling on the immediately-previous path, path 1 may be selected as the optimal path in a case where the shortest distance is determined as a cost function factor. Therefore, the mobile robot needs to greatly rotate a direction at the current location to move along the path 1, making it difficult to perform natural driving continuously.

Therefore, in this case, by determining the coincidence in direction with the immediately-previous path as a cost function factor, not the shortest distance, path 3 having a smallest difference in direction with the immediately-previous path may be selected as the optimal path, making it possible to continue the natural driving despite sudden appearance of obstacle 2.

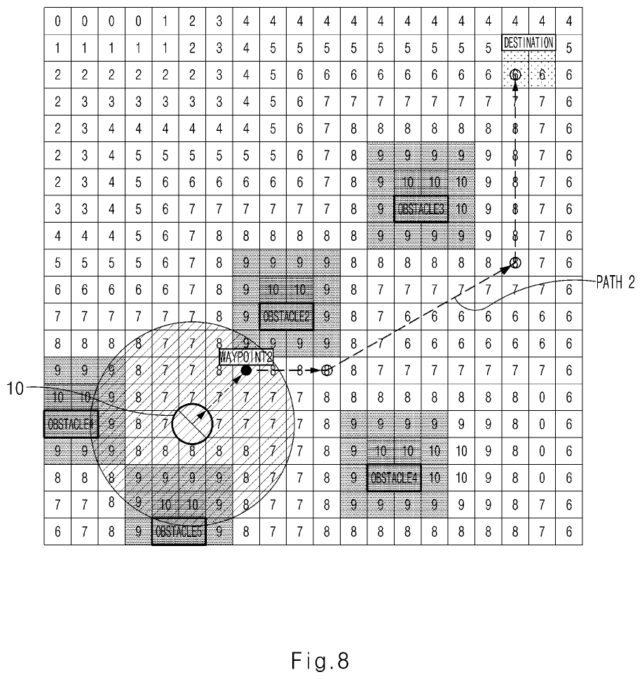

In addition, as shown in FIG. 8, when a driving condition requested from the mobile robot is to maintain a traveling direction of the mobile robot, the cost function factor determiner 310 may determine, as a cost function factor, a coincidence in direction with a direction pointed by the robot and the path selector 320 may determine, as an optimal path, path 2 having a smallest difference from a direction pointed by the robot (direction pointed by the arrow in the mobile robot indicated by a circle in FIG. 8) among eight multiple paths generated by the multi-path generation module 200.

When the traveling direction of the mobile robot is repeatedly changed while the mobile robot is driving, the robot's movement may be unnatural. Therefore, when it is desired to minimize a change in the traveling direction of the robot in the case of selecting the next path, the coincidence in direction with a direction pointed by the robot may be determined as a cost function factor for natural movement.

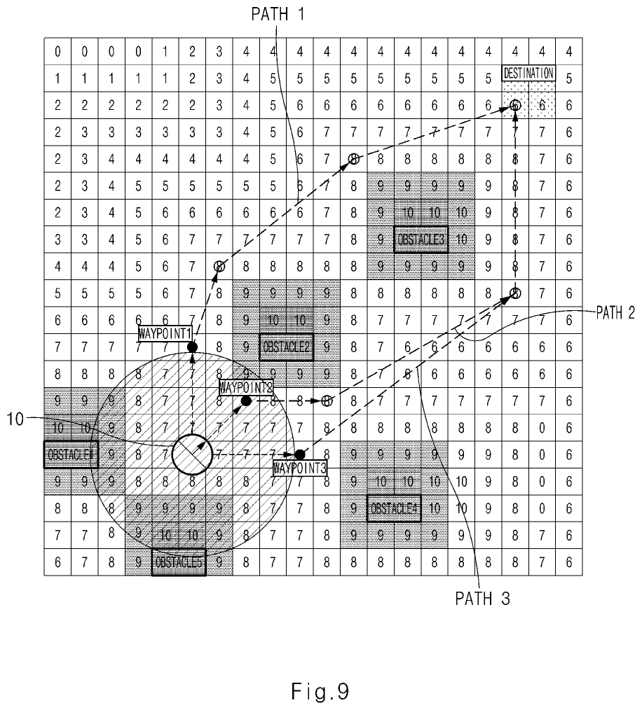

In addition, as shown in FIG. 9, when the driving condition requested from the mobile robot is to minimize left and right rotation, the cost function factor determiner 310 may determine, as a cost function factor, a coincidence in direction with an immediately-previous driving signal of the robot driver, and the path selector 320 may select path 1 as the optimal path if the mobile robot is turning left using the immediately-previous driving signal of the robot driver, and select path 2 or path 3 as the optimal path if the mobile robot is tuning right.

That is, when a path on the left is selected in a case where the mobile robot is turning right, the mobile robot may unnaturally drive because the mobile robot needs to turn to the left. Therefore, in this case, natural driving may be realized by selecting an optimal path from among paths in the direction in which the mobile robot is rotating (for example, paths on the right when the mobile robot is tuning right or paths on the left when the mobile robot is turning left) and then allowing the mobile robot to continuously drive.

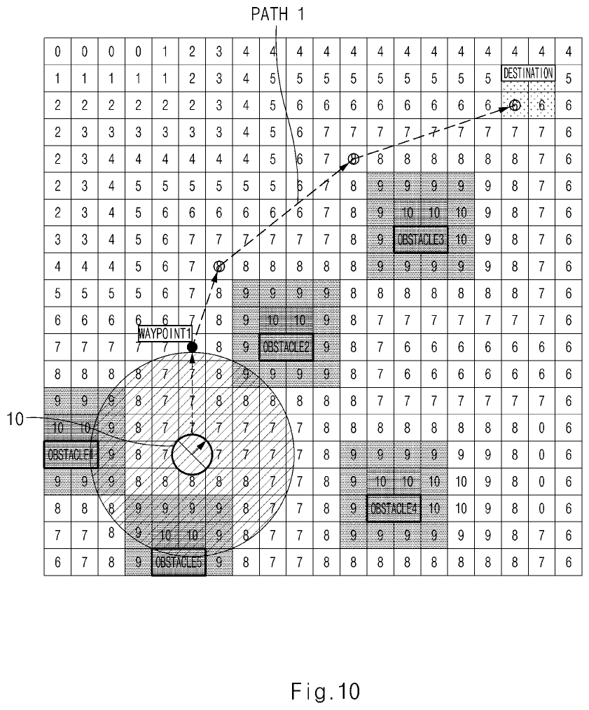

In addition, as shown in FIG. 10, when the driving condition requested from the mobile robot is to preferentially drive in an area in which a safe distance from an obstacle is secured, the cost function factor determiner 310 may determine, as a cost function factor, safety of the cost map or congestion of the cost map, and the path selector 320 may select a path with the minimum cost as the optimal path by calculating a cumulative or average cost value in a case where the mobile robot drives along each of paths by referring to a cost value matched to each area on the cost map. In addition, the path selector 320 may select a path with the minimum cost by calculating a cumulative or average cost value in a case where the mobile robot drives along each of paths by referring to a cost value matched to an area in the proximity of each path.

As described above, the multi-path generation module 200 may generates “n” multiple paths along which one mobile robot reaches a destination from a current location, and the optimal path selection module 300 may select an optimal path suitable for various driving conditions required for the mobile robot among the generated “n” multiple paths merely by changing the cost function factor.

The path control module 400 may generate a control signal for allowing the mobile robot to turn left or right, or drive straight such that the mobile robot reaches a destination along an optimal path selected by the optimal path selection module 300 and then transmit the control signal to a robot driver 14 provided in the mobile robot 10.

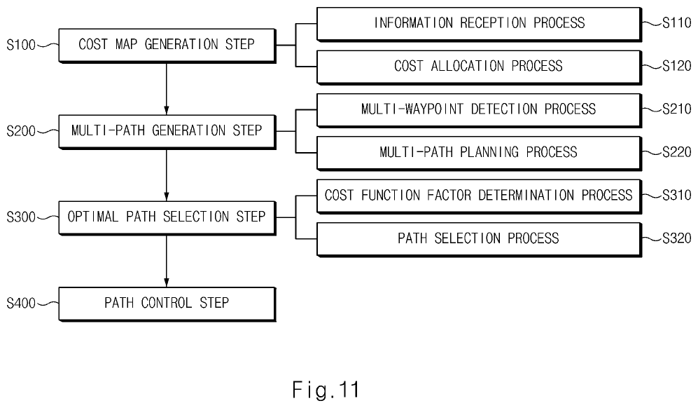

Next, a method for generating multiple paths of a mobile robot according to another embodiment of the present disclosure will be described with reference to FIG. 11.

A method for generating multiple paths of a mobile robot according to another embodiment of the present disclosure may include a cost map generation step (S100) of generating a cost map in which a cost is differentially allocated to areas according to a distance from an obstacle by using map information on a space divided into a plurality of areas and obstacle information on an obstacle in the space, a multi-path generation step (S200) of detecting “n” multiple waypoints located at the maximum straight line distance without collision with an obstacle in a space within a predetermined radius in “n” directions centered on the mobile robot, and planning “n” multiple paths to a destination by passing through each of the multi waypoints as an initial waypoint, an optimal path selection step (S300) of selecting a path satisfying a preset cost function requirement among the “n” multiple paths, which are planned, as an optimal path, and a path control step (S400) of transmitting a control signal for controlling the mobile robot to a robot driver of the mobile robot to follow the selected optimal path to reach a destination.

The cost map generation step 100 may include an information reception process (S110) of receiving and storing map information in which a space in which the mobile robot is movable is divided into a plurality of regions and information about an obstacle located in the space, and a cost allocation process (S120) of differentially allocating a cost according to how far each region resulting from division of the space is from an obstacle and then generating a cost map by matching the costs to the regions respectively.

In this way, the cost map generated by the cost map generation step (S100) may be stored in a storage device such as a separate memory, and used for detection of multiple waypoints and generation of multiple paths in the multi-path generation step (S200).

In addition, in the information reception process (S110), obstacle information may be received after being recognized and transmitted by the sensor device including various obstacle detection sensors such as a camera or lidar provided in the mobile robot. The obstacle information may include information such as a location in the space to which the mobile robot is to move and the size and shape of an obstacle occupied in the space.

In addition, in the cost allocation process (S120), a higher cost may be allocated as an area resulting from division of the space is closer to the obstacle, and a lower cost may be allocated as an area resulting from division of the space is further away from the obstacle, and a cost map may be generated by storing a cost value thereof along with map information and obstacle information. Accordingly, the determination as to which area of areas is to be included in a path and which area of areas is to be avoided may be achieved merely by comparing the costs allocated to the areas with each other.

As an example of a cost map generated in the cost map generation step (S100), the highest cost of 10 may be allocated to an area occupied by an obstacle, and a decreased cost may be allocated as it is further away from the area occupied by the obstacle.

In addition, in the cost allocation process (S120), not only a distance from the area occupied by the obstacle may be set as cost conditions for differentially allocating the cost, and but also, a cost may be differently allocated to the areas by using, as cost conditions, heat map information of maps, obstacle recognition results, or the like.

The multi-path generation step (S200) may include a multi-waypoint detection process (S210) of detecting, as “n” multiple waypoints, areas located on the maximum straight line distance without collision with an obstacle in “n” directions (n is an integer greater than or equal to 2) centered on the mobile robot located on the cost map and a multi-path planning process (S220) of planning “n” multiple paths to reach a destination by avoiding the obstacle while passing through each of the multiple waypoints as an initial waypoint.

In this case, the multi-waypoint detection process (S210) may include detecting, as multiple waypoints, areas located at the maximum straight line distance without collision with an obstacle in each of a plurality of directions movable from the current position of the mobile robot.

In addition, each of the multiple waypoints detected by the multi-waypoint detection process (S210) acts as an initial waypoint for planning multiple paths, so that a space in which the multiple waypoints may be detected is limited to a distance within a preset radius from the mobile robot.

In addition, the multi-waypoint detection process (S210) may include setting, as an area where there is no collision with an obstacle, an area allocated a cost of no greater than 8, which is lower than a cost of 10 indicating that a cost allocated to each area represents an area occupied by an obstacle on the cost map and is lower than a cost of 9 indicating that the cost allocated to each area represents a nearest area to the obstacle on the cost map, to avoid an area with collision with the obstacle. In this case, the multi-waypoint detection process (S210) may include changing and setting a cost for determining an area without collision with obstacles to a value lower than or higher than 8.

In addition, the multi-path planning process (S220) may include planning “n” multiple paths through which the mobile robot is able to reach a destination by avoiding the obstacle while passing through each of the multiple waypoints as the initial waypoint. In this case, planning “n” multiple paths may mean generating a path through which the mobile robot is able to reach the destination from the current location based on various algorithms.

In this case, the “n” multiple paths generated by the multi-path planning process (S220) such that the mobile robot reaches the destination from the current position of the mobile robot via each initial waypoint may be generated according to various methods capable of generating an optimal path for movement of a robot, such as Dijkstra algorithm, A* algorithm, JPS (Jump Point Search) algorithm, RRT (Rapidly-exploring Random Tree) algorithm, or the like. In addition, the multi-path planning process (S220) may include performing post-processing such as shortening and interpolation in planning each of the multiple paths.

As described above, the multi-path planning process (S220) may include generating a plurality of paths as many as the number of multiple waypoints detected by the multi-waypoint detector 210 to generate the plurality of paths selectable when the one mobile robot is to reach a destination from a current location.

In addition, the optimal path selection step (S300) may include a cost function factor determination process (S310) of determining a cost function factor for selecting a path from among the “n” multiple paths generated by the multi-path generation module, and a path selection process (S320) of selecting a path to a destination according to the cost function factor determined by the cost function factor determiner 310 among the “n” multiple paths, as an optimal path to be followed by the mobile robot.

In this case, the cost function factor determination process (S310) may including selecting various cost function factors or a combination of at least two or more cost function factors according to a driving condition requested during the movement of the mobile robot to reach the destination.

Accordingly, the cost function factor determination process (S301) may include selecting and determining, as a cost function factor for path selection, one of various cost function factors, such as a shortest distance, minimum cumulative rotation, a direction coincidence with an immediately-previous path, a direction coincidence with a direction pointed by the robot, a direction coincidence with a previous driving signal of the robot driver, cost map stability, cost map congestion, or the like, or a combination of at least two or more cost function factors.

In addition, the path selection process (S320) may include selecting an optimal path to be followed by the mobile robot according to one cost function factor selected by the cost function factor determination process or a combination of at least two or more cost function factors.

As described above, in the path selection process (S320), it is possible to easily select a suitable path of a plurality of paths for one mobile robot to reach the same destination from a current location and adopt the suitable path as a path of the mobile robot, thereby enabling the mobile robot to follow a path suitable for a driving condition through path diversification.

The path control step (S400) may include generating a control signal for allowing the mobile robot to turn left or right, or drive straight such that the mobile robot reaches a destination along an optimal path selected by the optimal path selection step and transmitting the control signal to a robot driver provided in the mobile robot.

As described above, the multi-path generation step may include generating “n” multiple paths along which one mobile robot reaches a destination from a current location, and the optimal path selection step may include selecting an optimal path suitable for various driving conditions required for the mobile robot among the generated “n” multiple paths merely by changing the cost function factor.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the present disclosure, it is possible to detect multiple waypoints with safety distances secured in various directions from the current position of the mobile robot and use these multiple waypoints as the initial waypoints of each of paths when planning multiple paths, thereby generating multiple safe paths without collisions in various directions at the same time.

In addition, according to the present disclosure, it is possible to enabling the selection of an optimal path suitable for various driving conditions of the mobile robot by simultaneously generating multiple paths along which a single mobile robot may move from the current location to the destination.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for generating multiple paths for a mobile robot, the apparatus comprising:
a cost map generation module configured to generate a cost map in which a cost is differentially allocated to areas according to a distance from an obstacle by using map information on a space divided into a plurality of areas and obstacle information on an obstacle in the space,
a multi-path generation module configured to detect “n” multiple waypoints located at a maximum straight line distance without collision with the obstacle in “n” directions centered on the mobile robot, and plan “n” multiple paths to a destination by passing through each of the multiple waypoints as an initial waypoint,
an optimal path selection module configured to select a path satisfying a preset cost function requirement among the “n” multiple paths planned, as an optimal path; and
a path control module configured to transmit a control signal for controlling the mobile robot to follow the selected optimal path to reach the destination to a robot driver of the mobile robot.

2. The apparatus of claim 1, wherein the cost map generation module includes:
an information receiver configured to receive and store the map information in which the space in which the mobile robot is movable is divided into the plurality of areas and information about the obstacle located in the space, and
a cost allocator configured to differentially allocate a cost according to how far each area resulting from division of the space is from the obstacle and then generate the cost map by matching the costs to the areas respectively.

3. The apparatus of claim 2, wherein the cost allocator allocates a relatively high cost as an area resulting from division of the space is closer to the obstacle, allocates a lowest cost to a farthest area by linearly decreasing the cost as the area resulting from division of the space is further away from the obstacle, and stores a cost value thereof along with the map information and the obstacle information.

4. The apparatus of claim 2, wherein the cost allocator allocates a relatively high cost as an area resulting from division of the space is closer to the obstacle, allocates a relatively low cost to an area by non-linearly decreasing the cost rapidly as the area resulting from division of the space is further away from the obstacle, and stores a cost value thereof along with the map information and the obstacle information.

5. The apparatus of claim 2, wherein the cost allocator differentially allocates the cost to areas based on a distance from the area occupied by the obstacle, heat map information of maps, or obstacle recognition results.

6. The apparatus of claim 1, wherein the multi-path generation module includes:
a multi-waypoint detector configured to detect, as the “n” multiple waypoints, areas located on the maximum straight line distance without collision with an obstacle in the “n” directions (n is an integer greater than or equal to 2) centered on the mobile robot located on the cost map, and
a multi-path planning device configured to plan the “n” multiple paths to reach the destination by avoiding the obstacle while passing through each of multiple waypoints as an initial waypoint.

7. The apparatus of claim 6, wherein the multi-path generation module limits a space in which the multiple waypoints are able to be detected to a distance within a preset radius from the mobile robot.

8. The apparatus of claim 6, wherein the optimal path selection module includes:
a cost function factor determiner configured to determine a cost function factor for selecting a path from among the “n” multiple paths generated by the multi-path generation module, and
a path selector configured to select a path to a destination according to the cost function factor determined by the cost function factor determiner among the “n” multiple paths, as an optimal path to be followed by the mobile robot.

9. The apparatus of claim 8, wherein the cost function factor determiner selects and determines, as a cost function factor for path selection, one of a shortest distance, minimum cumulative rotation, a direction coincidence with an immediately-previous path, a direction coincidence with a direction pointed by the robot, a direction coincidence with an immediately-previous driving signal of the robot driver, cost map stability, or cost map congestion or a combination of at least two or more cost function factors selected.

10. The apparatus of claim 9, wherein, when a driving condition requested from the mobile robot is to minimize a moving distance of the robot, the cost function factor determiner determines a shortest distance as a cost function factor and the path selector selects a path having a shortest distance to the destination among the “n” multiple paths generated by the multi-path generation module, as an optimal path.

11. The apparatus of claim 9, wherein, when a driving condition requested from the mobile robot is to minimize rotation of the mobile robot among paths to the destination, the cost function factor determiner determines minimum cumulative rotation as a cost function factor and the path selector selects a path of which a cumulative rotation value is a minimum among the “n” multiple paths generated by the multi-path generation module, as an optimal path.

12. The apparatus of claim 9, wherein, when a driving condition requested from the mobile robot is for the mobile robot to maintain a direction of a path along which the mobile robot had moved immediately previously to perform natural driving continuously, the cost function factor determiner determines, as a cost function factor, a coincidence in direction with an immediately-previous path, and the path selector determines, as an optimal path, a path having a smallest difference in the direction with the immediately-previous path among the “n” multiple paths generated by the multi-path generation module.

13. The apparatus of claim 9, wherein, when a driving condition requested from the mobile robot is to maintain a traveling direction of the mobile robot, the cost function factor determiner determines, as a cost function factor, a coincidence in direction with a direction pointed by the robot and the path selector determines, as an optimal path, a path having a smallest difference from the direction pointed by the robot among “n” multiple paths generated by the multi-path generation module.

14. The apparatus of claim 9, wherein, when a driving condition requested from the mobile robot is to reduce left and right rotation, the cost function factor determiner determines, as a cost function factor, a coincidence in direction with an immediately-previous driving signal of the robot driver, and the path selector selects a path on left side as the optimal path, when the mobile robot is turning left using the immediately-previous driving signal of the robot driver, and selects a path on right side as the optimal path when the mobile robot is turning right.

15. A method for generating multiple paths for a mobile robot, comprising the steps of:
a cost map generation step of generating, by a cost map generation module, a cost map in which cost is differentially allocated to areas according to a distance from an obstacle by using map information on a space divided into a plurality of areas and obstacle information on an obstacle in the space;
a multi-path generation step of detecting, by a multi-path generation module, “n” multiple waypoints located at a maximum straight line distance without collision with the obstacle in “n” directions centered on the mobile robot, and planning “n” multiple paths to a destination by passing through each of the multiple waypoints as an initial waypoint;
an optimal path selection step of selecting, by an optimal path selection module, a path satisfying a preset cost function requirement among the “n” multiple paths planned, as an optimal path; and
a path control step of transmitting, by a path control module, a control signal for controlling the mobile robot to follow the selected optimal path to reach the destination to a robot driver of the mobile robot.

16. The method of claim 15, wherein the cost map generation step includes:
an information reception process of receiving and storing the map information in which the space in which the mobile robot is movable is divided into the plurality of areas and information about the obstacle located in the space, and
a cost allocation process of differentially allocating a cost according to how far each area resulting from division of the space is from an obstacle and then generate the cost map by matching the costs to the areas respectively.

17. The method of claim 15, wherein the multi-path generation step includes:
a multi-waypoint detection process of detecting, as the “n” multiple waypoints, areas located on the maximum straight line distance without collision with an obstacle in the “n” directions (n is an integer greater than or equal to 2) centered on the mobile robot located on the cost map, and
a multi-path planning process of planning the “n” multiple paths to reach the destination by avoiding the obstacle while passing through each of the multiple waypoints as an initial waypoint.

18. The method of claim 17, wherein the multi-waypoint detection process includes limiting a space in which the multiple waypoints are able to be detected to a distance within a preset radius from the mobile robot.

19. The method of claim 17, wherein the optimal path selection step includes:
a cost function factor determination process of determining a cost function factor for selecting a path from among the “n” multiple paths generated in the multi-path generation step, and
a path selection process of selecting a path to the destination according to the cost function factor determined in the cost function factor determination process among the “n” multiple paths, as an optimal path to be followed by the mobile robot.

20. The method of claim 18, wherein the cost function factor determination process includes selecting and determining, as a cost function factor for path selection, one of a shortest distance, minimum cumulative rotation, a direction coincidence with an immediately-previous path, a direction coincidence with a direction pointed by the robot, a direction coincidence with an immediately-previous driving signal of the robot driver, cost map stability, or cost map congestion, or a combination of at least two or more cost function factors.
